(19) United States
(12) Patent Application Publication
(10) Pub. No.: US 2025/0030792 A1
(43) Pub. Date: Jan. 23, 2025

(54) SYSTEMS AND METHODS FOR DEVICE MESSAGING

(71) Applicant: Apple Inc., Cupertino, CA (US)

(72) Inventors: Joseph K. Walnes, Los Gatos, CA (US); Anil K. Kandangath, San Francisco, CA (US)

(21) Appl. No.: 18/778,342

(22) Filed: Jul. 19, 2024

Related U.S. Application Data
(60) Provisional application No. 63/527,624, filed on Jul. 19, 2023.

(51) Int. Cl. H04M 1/72436; H04M 1/72454; H04M 3/42

(52) U.S. Cl. CPC H04M 1/72436; H04M 1/72454; H04M 3/42365

(57) ABSTRACT

Systems and methods described herein provide device messaging. In some examples, an unattended target electronic device is identified amongst multiple devices. A message for the user of the target electronic device is obtained at the electronic device. The message for the user of the target electronic device is sent from the electronic device to the target electronic device. The message is relayed to a device associated with the user.

### CROSS-REFERENCE TO RELATED APPLICATIONS

The present application claims priority to U.S. Provisional Application No. 63/527,624 filed Jul. 19, 2023, which is incorporated by reference in its entirety herein.

### FIELD

Aspects of the present disclosure relate to systems and methods for device messaging and in some examples sending a message to a user of an unattended electronic device.

### BACKGROUND

In some contexts, there may be a desire to communicate with a user of an electronic device when the electronic device is unattended by the user. However, such communication is challenging when contact information for the user is unknown.

### SUMMARY

Implementations described and claimed herein provide systems and methods for device messaging. In some implementations, a target electronic device in a vicinity of an electronic device is identified. The target electronic device is unattended by a user of the target electronic device. A message for the user of the target electronic device is obtained at the electronic device. The message for the user of the target electronic device is sent from the electronic device to the target electronic device, and the message is relayed to a user device associated with the user via the target electronic device.

In some implementations, one or more message delivery parameters is obtained at a target electronic device. The one or more message delivery parameters is customized using user input from a user associated with the target electronic device. A request for message delivery is received from an electronic device in a vicinity of the target electronic device. The one or more message delivery parameters is sent to the electronic device in response to the request for message delivery. A message for the user is received at the target electronic device from the electronic device. The message is configured according to the one or more message delivery parameters. The message is sent from the target electronic device to a user device associated with the user.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 shows an example environment for device messaging.

FIG. 2 shows an example electronic device.

FIG. 3 illustrates example operations for device messaging.

FIG. 4 illustrate other operations for device messaging.

FIG. 5 shows an example computing system.

### DETAILED DESCRIPTION

Aspects of the presently disclosed technology relate to systems and methods for device messaging. It may be desirable to provide a message for a user associated with a particular electronic device. If the particular electronic device is unattended by the user, it is challenging to send the message to the user. These challenges are exacerbated when the message is time sensitive and/or the contact information for the user is unknown. As such, a target electronic device is identified, and a message for a user is obtained at an electronic device. The message for the user is sent from the electronic device to a user device associated with the user via the target electronic device. Accordingly, the presently disclosed technology facilitates delivery of messages, including those with time sensitive content, to a user that may be at a separate location from an electronic device without providing contact information or other identifying information for the user to the source of the message.

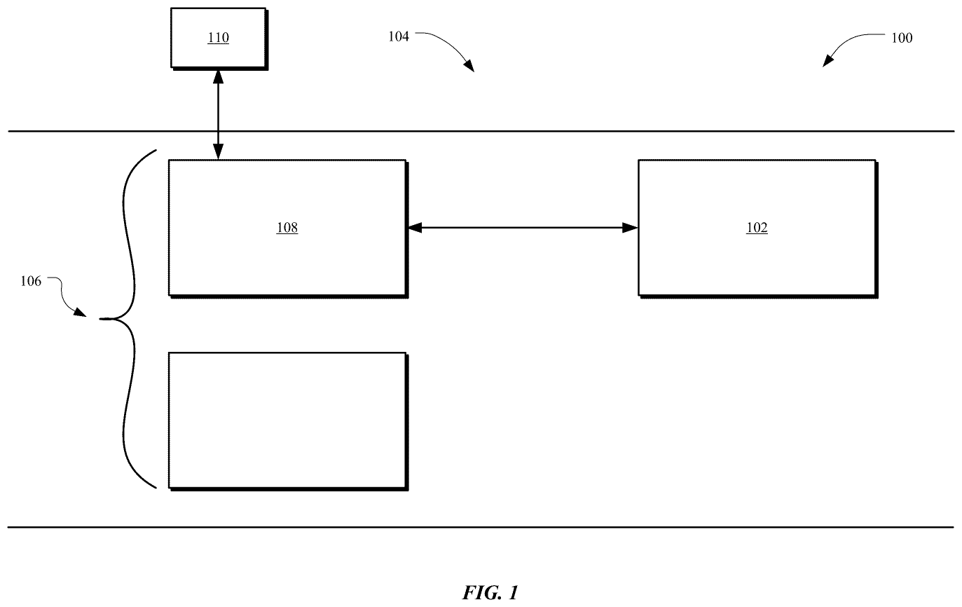

To begin a detailed description of an example environment 100 for device messaging, reference is made to FIG. 1. In some implementations, the environment 100 includes a first electronic device 102 disposed in a vicinity 104 of one or more second electronic device(s) 106. The vicinity 104 may correspond to a physical relationship, communication relationship, sensor relationship, and/or other relationship between the first electronic device 102 and the second electronic device(s) 106. In some examples, the physical relationship corresponds to a distance between the first electronic device 102 and the second electronic device(s) 106, a radius extending from the first electronic device 102, an area along one or more vectors extending from the first electronic device 102, and/or other spatial parameters. The communication relationship may include a communication range of the first electronic device 102, a connectivity between the first electronic device 102 and the second electronic device(s) 106, and/or other communication parameters. The sensor relationship may include one or more fields of view of corresponding sensor(s) of the first electronic device 102 and/or based on sensor data captured by the sensor(s) of the first electronic device 102.

The second electronic device(s) 106 may be detected in the vicinity 104 of the first electronic device 102 or otherwise be determined to be available for messaging in a variety of manners. For example, the second electronic device(s) 106 may be detected based on sensor data captured by the sensor(s) of the first electronic device 102, line-of-sight of the sensor(s) of the first electronic device 102, a wireless communication (e.g., connection to a network, signal, etc.), ultra-wideband (UWB) positioning signals, disambiguation of an indication by a user, detected as discoverable, detected as accepting communication and/or input, and/or the like. The sensor data may include, without limitation, images, depth data, and/or UWB corresponding to an environment external to the first electronic device 102. Using detection data (e.g., the sensor data, user input, discoverable data, communication data, connectivity, etc.), the first electronic device 102 may detect objects in the environment and identify the objects as the second electronic device(s) 106 in the vicinity 104 of the first electronic device 102.

There may be various scenarios in which it may be desirable to leave a message for user(s) of one or more of the second electronic device(s) 106, which may be in the vicinity 104. The user(s) may be any person associated with the second electronic device(s), including without limitation, wearers, owners, operators, managers, occupants, drivers, riders, and/or individuals authorized to access, operate, use and/or are otherwise associated with the second electronic device(s). A target electronic device 108 may be identified for sending a message. In some examples, the target electronic device 108 is unknown to the first electronic device 102 (e.g., the first electronic device 102 has not previous exchanged communications with, paired with, received signals from, sent signals to, and/or captured data corresponding to the target electronic device 108). The target electronic device 108 may be identified from the second electronic device(s) 106 detected in the vicinity 104 of the first electronic device 102. In some examples, the target electronic device 108 is identified based on a selection of the target electronic device 108 from the second electronic device(s) 106. The target electronic device 108 may be selected based on user input, detection of a device messaging condition corresponding to the target electronic device 108, and/or a capability of the first electronic device 102 to communicate with the target electronic device 108.

The user input may be captured using an interface system of the first electronic device 102. For example, the interface system may present corresponding representation(s) of the second electronic device(s) 106 detected in the vicinity of the first electronic device 102 (and in some cases available for messaging), and a user associated with the first electronic device 102 selects the target electronic device 108 from the corresponding representation(s) of the second electronic device(s) 106. In another example, the interface system of the first electronic device 102 detects the user input in the form of an indication by the user of the first electronic device 102. The indication may be a gesture by the user, a verbal description, and/or the like. The first electronic device 102 may disambiguate the indication by detecting the second electronic device(s) 106 in the vicinity 104 of the first electronic device 102 and correlating at least one indication feature of the indication with one or more characteristics of the target electronic device 108 and/or a position of the target electronic device 108. For example, the indication may include a description of an intended electronic device and/or the position of the intended electronic device (e.g., location and/or orientation within the external environment). The description is compared with sensor data and/or descriptions of the second electronic device(s) 106 to correlate the indication description to the target electronic device 108 (e.g., using natural language processing techniques). In another example, a direction of the indication may be correlated with a position of the target electronic device 108 relative to the first electronic device 102 in the external environment.

The device messaging condition corresponding to the target electronic device 108 may include, without limitation, a device status condition, an event occurrence, a device action condition, an object condition, and/or a user condition. The device status condition may correspond to a status, state, and/or operation of the target electronic device 108. For example, the device status condition may include, without limitation, a charge level of a battery, the electronic target device 108 being unlocked or locked, discoverable, available over a wireless ad hoc network (WANET) and/or a mobile ad hoc network (MANET), in an idle state, being worn, available for receiving input and/communication, lights left on, presence of a maintenance issue, a component in an open or closed state, unattended, etc. The event occurrence may correspond to an occurrence of an event involving the target electronic device 108, including but not limited to an event resulting in damage to the target electronic device 108, the target electronic 108 being left behind by the user, etc. The device action condition may correspond to an action that has been taken or requested to be taken by the target electronic device 108 (e.g., move the target electronic device 108 to a new location). The object condition may correspond to a condition of objects associated with the target electronic device 108 (e.g., objects in an interior of the target electronic device 108, accessories attached to the target electronic device 108, etc.). The user condition may correspond to a condition of one or more users associated with the target electronic device 108. The device messaging condition corresponding to the target electronic device 108 may be detected based on the sensor data captured by the first electronic device 102, sensor data captured by the target electronic device 108, communications sent by the target electronic device 108, and/or user input.

In some implementations, a state of the target electronic device 108 is determined. For example, a first state may be an unavailable state, and a second state may be an available state. The available state corresponds to an availability of the target electronic device 108 to accept messages. In the available state, the target electronic device 108 may be unattended by the user of the target electronic device 108. The target electronic device 108 may be determined to be unattended based on a determination of whether the user associated with the target electronic device 108 is in the vicinity 104. The target electronic device 108 may be determined to be unattended by the target electronic device 108, the first electronic device 102, and/or other devices in the vicinity 104. For example, sensor data and/or user input may be used to determine whether any users are present in an interior of the target electronic device 108. Sensor data and/or user input may be similarly used to determine whether the user exited the target electronic device 108 and/or the vicinity 104. The target electronic device 108 may be determined to be in locked or unlocked states, with the target electronic device 108 being determined to be unattended when the target electronic device 108 is locked. The target electronic device 108 may be determined to be unattended based on a user device 110 associated with the user of the target electronic device 108. For example, the unavailable state may correspond to the user device 110 being detected within the vicinity 104, and the available state may correspond to the user device 110 being at a remote location (e.g., not detected within the vicinity 104, detected at a remote location, etc.). In another example, the target electronic device 108 may be determined to be unattended based on a communication distance between the target electronic device 108 and the user device 110. The communication distance may be determined based on a communications protocol, such as a short-range protocol (e.g., Bluetooth Low Energy (BTLE), UWB, fob transponder protocols, etc.).

In some examples, the target electronic device 108 is a smartphone, laptop, tablet, desktop, and/or the like, and the available state corresponds to target electronic device 108 being locked. In some examples, the target electronic device 108 is a smartphone, laptop, tablet, desktop, wearable, asset tracking tag, and/or the like, and the available state corresponds to target electronic device 108 being unattended. In some examples, the target electronic device 108 is a smartphone, laptop, tablet, desktop, wearable, asset tracking tag, and/or the like, and the available state corresponds to target electronic device 108 being discoverable and/or available to accept messages (e.g., over a wireless network, such as a WANET/MANET, etc.). In some examples, the target electronic device 108 is a wearable, and/or the like, and the available state corresponds to target electronic device 108 being worn and/or available to accept messages. In some examples, the target electronic device 108 is a home hub, television system, speaker, audio-based text to speech device, stationary device, and/or the like, and the available state corresponds to target electronic device 108 being idle (e.g., not engaged in content presentation/output, etc.), available to accept user input, and/or available to accept messages. It will be appreciated that various target electronic devices 108 may be configured to provide an available state in a variety of manners.

The state may further correspond to a service and/or operation of the target electronic device 108. For example, the available state may involve charging the target electronic device 108 (e.g., the target electronic device 108 is connected to a charging station for charging), and the unavailable state may involve the target electronic device 108 moving along a travel path and/or performing one or more operations. The target electronic device 108 transitions to the available state according to user preferences and/or one or more triggers, including but not limited to, user input, and/or detection of the target electronic device 108 being unattended by the user of the target electronic device 108. In some implementations, the user associated with the target electronic device 108 sets the target electronic device 108 to the available state using user input and/or customizes the trigger for transitioning the target electronic device 108 to the available state.

The target electronic device 108 may be selected from a subset of the second electronic device(s) 106 based on the state of each of the second electronic device(s) 106. In one example, the first electronic device 102 may determine which of the second electronic device(s) 106 in the vicinity 104 is in the available state and which is in the unavailable state and present a representation of an availability status of nearby devices.

The user may further customize aspects of message delivery, including, but not limited to, customizing one or more message delivery parameters. The message delivery parameter(s) may be customized based on user input captured by the target electronic device 108, the user device 110, and/or other computing systems. The message delivery parameter(s) may include one or more preset messages, content parameters (e.g., what the message may contain, etc.), temporal parameters (e.g., when a message can be received at the target electronic device 108, etc.), condition parameters (e.g., how a message can be received at the target electronic device 108, etc.), sender parameters (e.g., devices permitted to send a message, etc.), relay parameters (e.g., parameters corresponding to sending the message from the target electronic device 108 to the user device 110, etc.), and/or other preferences for accepting messages for the user at the target electronic device 108 and sending messages from the target electronic device 108 to the user device 110. In some implementations, messages are analyzed by the target electronic device 108 for compliance with the message delivery parameter(s) prior to taking additional action (e.g., sending the message to the user device 110). In other implementations, the message delivery parameters are communicated from the target electronic device 108 to the first electronic device 102 in response to a request for message delivery. The first electronic device 102 may be prevented from sending a message not in compliance or otherwise not configured in accordance with the message delivery parameter(s).

In some implementations, the first electronic device 102 identifies the target electronic device 108 and determines that the target electronic device 108 is in the available state for accepting messages. The first electronic device 102 and/or the target electronic device 108 obtains the message for the user of the target electronic device 108. The message may be captured using an interface system of the first electronic device 102 and/or an associated computing system (e.g., a user device disposed in an interior of the first electronic device 102 and/or associated with a user of the first electronic device 102). For example, the interface system may present the preset messages for selection by the first electronic device 102 and/or using user input. In another example, the interface system provides the message delivery parameter(s) and captures the message accordingly. In another example, the interface system captures the message based on user input in response to identification of the target electronic device 108. The message may be captured through device input, verbal input, visual input, tactile input, and/or other types of user input. The interface system may further present any response to the message or notification of noncompliance with the message delivery parameter(s). The message may be generated based on sensor data captured by the first electronic device 102. For example, the sensor data captured by the first electronic device 102 may be used by the first electronic device 102 to identify a device messaging condition corresponding to the target electronic device 108 and automatically generate a message for sending to the target electronic device 108 regarding the condition. Generally, the message may include content related to the device messaging condition corresponding to the target electronic device 108, time sensitive content, and/or other information for the user associated with the target electronic device 108. In some implementations, the message is analyzed by the target electronic device 108 and/or the first electronic device 102 for compliance with the message delivery parameter(s).

In some implementations, the message is sent from the first electronic device 102 to the target electronic device 108, which sends the message to a user device 108 associated with the user. The user device 108 may be identified based on a prior connection with the target electronic device 108, a user profile for the user accessible to the target electronic device 108, user input, and/or the like. The message may be sent from the target electronic device 108 to the user device 110 synchronously with receipt from the first electronic device 102 in some instances. In some examples, the message is analyzed for compliance with the message delivery parameter(s) prior to sending to the user device 110.

The target electronic device 108, the first electronic device 102, and/or the second electronic device(s) 106 may be a mobile device, speaker, security system, camera, robot, a charging station, vehicle, a maintenance system, a traffic system, smartphone, wearable, laptop, tablet, home system, home hub, content system, asset tracking tag, television system, audio-based text to speech devices, and/or other computing systems. The target electronic device 108, the first electronic device 102, and/or the second electronic device(s) 106 may combinations of the same and/or different devices. The user device 110 may be a smartphone, wearable, laptop, tablet, home hub, speaker, home system, television system, content system, audio-based text to speech devices, and/or other devices used by or otherwise associated with the user of the target electronic device 108. The message may be sent from the first electronic device 102 to the target electronic device 108 using a first wireless connection, and from the target electronic device 108 to the user device 110 using a second wireless connection. The wireless connections may use the same or different communication protocols and/or the same or different systems from each other. The wireless connections may involve various combinations of Bluetooth, Wi-Fi, UWB, Vehicle-to-vehicle (V2V), Vehicle-to-everything (V2X), Vehicle-to-infrastructure (V2I), cellular, satellite, radio, and/or other communication protocols. In some implementations, the target electronic device 108 serves as a unidirectional messaging service for the user to receive and relay messages from the first electronic device 102 to the user device 110. In this manner, information, including time sensitive content, may be received by the user when remote from the target electronic device 108, while maintaining privacy of contact information for the user device 110.

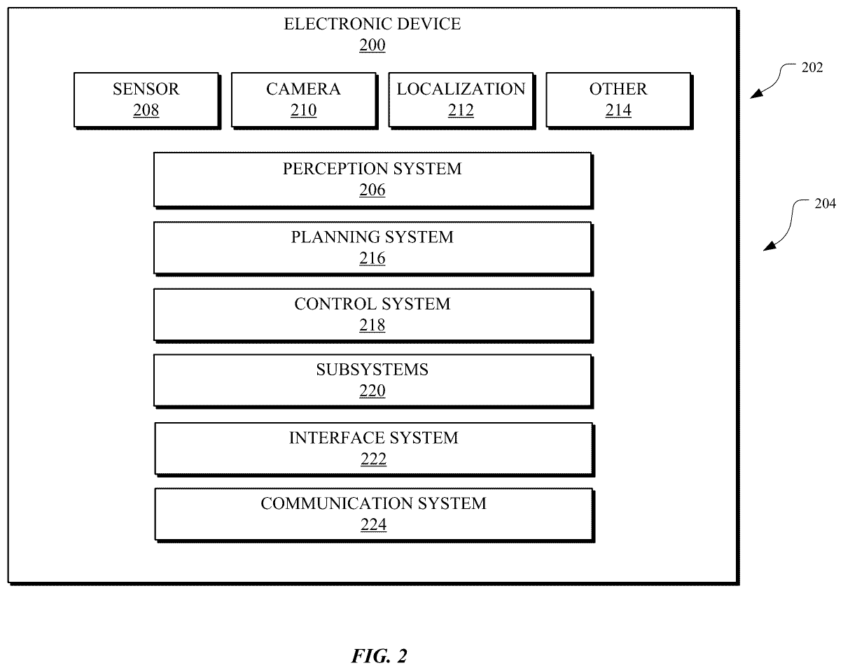

Turning to FIG. 2, an example electronic device 200, which may be the first electronic device 102, the second electronic device(s) 106, the target electronic device 108, and/or other electronic devices, is shown. In some implementations, the electronic device 200 includes one or more sensor systems 202 and device systems 204. It will be appreciated that any of a perception system 206, LIDAR sensors 208, cameras 210, localization systems 212, other sensors 214, a planning system 216, a control system 218, subsystems 220, an interface system 222, and/or a communication system 224 may be part of or separate from the device systems 206. Further, the interface system 222 and the communication system 224 may be separate from and/or part of the subsystems 220.

The sensor system 202 includes one or more sensors configured to capture sensor data, including, but not limited to: data of a field of view of the electronic device 200 (e.g., one or more images); data corresponding to the vicinity 104; localization data corresponding to a location, heading, and/or orientation of the electronic device 200; movement data corresponding to motion of the electronic device 200; and/or data corresponding to the second electronic device(s) 106, including the target electronic device 108. The one or more sensors of the sensor system 202 may include, without limitation, 3D sensors configured to capture 3D images, 2D sensors configured to capture 2D images, RADAR sensors, infrared (IR) sensors, optical sensors, and/or visual detection and ranging (ViDAR) sensors. For example, the one or more 3D sensors may include the LIDAR sensors 208 (e.g., scanning LIDAR sensors) or other depth sensors, and the one or more 2D sensors may include the cameras 210 (e.g., RGB cameras). The cameras 210 may capture color images, grayscale images, and/or other 2D images. The localization systems 212 may capture the localization data. The localization systems may include, without limitation, GNSS, inertial navigation system (INS), inertial measurement unit (IMU), global positioning system (GPS), altitude and heading reference system (AHRS), compass, and/or accelerometer. The other sensors 214 may be used to capture localization data, movement data, access identification data, and/or other authorized and relevant sensor data.

The perception system 204 can generate perception data, which may detect, identify, classify, and/or determine position(s) of one or more objects, such as the second electronic device(s) 106 and the target electronic device 108, using the sensor data. The perception data may be used by a planning system 216 in generating one or more actions for the electronic device 200, such as generating a navigation plan having at least one movement action for autonomously navigating the electronic device 200 along a travel path from an origin towards a destination. A control system 218 may be used to control various operations of the electronic device 200, including, but not limited to, generating a message, executing the navigation plan, and/or other operations. The navigation plan may include various operational instructions for subsystems 220 of the electronic device 200 to autonomously execute to perform the navigation action(s), as well as other action(s), such that the electronic device 200 moves on its own planning and decisions. Instructions for operating the electronic device 200 in view of a movement path may be executed by the planning system 216, the control system 218, the subsystems 220, and/or other components of the electronic device 200. The instructions may be modified prior to execution by the electronic device 200 (e.g., using the interface system 222), and in some cases, the electronic device 200 may disregard the instructions, for example, based on the sensor data captured by the sensor system 202.

In some implementations, the interface system 222 includes a presentation system and an input system. The user device 110 may include an interface system similar to the interface system 222. The input system of the interface system 222 may include one or more input devices configured to capture various forms of user input. For example, the interface system 222 may be configured to capture visual input (e.g., information provided via gesture), audio input (e.g., information provided via voice), tactile input (e.g., information provided via touch, such as via a touch-sensitive display screen (“touchscreen”), etc.), device input (e.g., information provided via one or more input devices), and/or the like from a user. Similarly, the presentation system of the interface system 222 may include one or more output devices configured to present output data in various forms, including visual (e.g., via display, projection, etc.), audio, and/or tactile. The interface system 222 may include various software and/or hardware for input and presentation. The input system and the presentation system may be integrated into one system, in whole or part, or separate. For example, the input system and the presentation system of the interface system 222 may be provided in the form of a touchscreen.

In some implementations, the interface system 222 provides an interactive interface. The interactive interface may be deployed in the electronic device 200. For example, the interactive interface may be deployed in an interior of the electronic device 200. In this context, the interface system 222 may be provided via an instrument panel, such as interactive dashboard having a touchscreen, a heads-up-display, and/or the like. The communication system 224 may include, without limitation, one or more antennae, receivers, transponders, transceivers, and/or communication ports. In some cases, the communication system 224 includes a first communication system and the second communication system that have different hardware and/or software for communicating using different communication protocols and/or via different types of wireless networks. In some examples, the first communication system is configured for long-range communication (e.g., via cellular network, satellite network, radio, etc.) and/or to otherwise communicate with the user device 110, and the second communication system is configured for short-range communication (e.g., Bluetooth, Wi-Fi, UWB, etc.) and/or to otherwise communicate with the first and second electronic devices 102-104. The communication system 224 facilitates message delivery from the first electronic device 102 to the user device 110 via the target electronic device 108. In some examples, the electronic device 200 forms part of an answering service that specifies options for leaving a message for the user via the user device 110 according to message delivery parameters. The message may be analyzed for compliance with the message delivery parameters or selected from a set of preset messages. In some examples, the electronic device 200 forms part of a unidirectional line of communication for relaying a message to the user device 110.

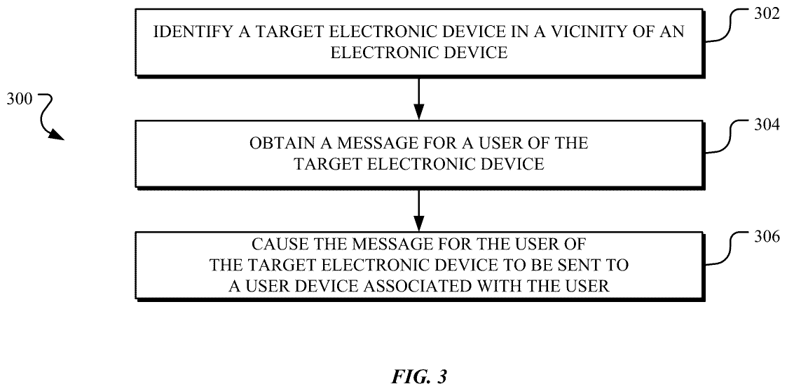

Referring to FIG. 3, example operations 300 for device messaging are illustrated. In some implementations, an operation 302 identifies a target electronic device. The target electronic device may be in a vicinity of an electronic device. The target electronic device may be unknown to the electronic device. Similarly, a user associated with the target electronic device and/or a corresponding user device may be unknown to the electronic device.

The target electronic device may be in available state for message. The available state generally corresponds to an availability of the target electronic device to accept messages. In the available state, the target electronic device may be unattended by the user of the target electronic device. In some examples, the target electronic device may be locked, no occupants may be detected in an interior of the target electronic device, etc. The target electronic device may otherwise be in an available state, such as being discoverable on a network for communication, and/or the like as described herein.

In some implementations, the operation 302 detects one or more electronic devices in the vicinity of the electronic device and selects the target electronic device from the one or more electronic devices. The one or more electronic devices may be detected based on a field of view of the electronic device, a wireless connection of the electronic device, UWB positioning, etc. In one example, one or more images captured using a camera of the electronic device are used to detect the one or more electronic devices. In another example, at least one antenna of the electronic device transmits wireless communication signals (e.g., UWB positioning signals), and the one or more electronic devices are detected in response thereto. The target electronic device may be selected based on at least one of user input or detection of a device messaging condition corresponding to the target electronic device. A representation of each of the one or more electronic devices may be presented (e.g., using a presentation system of the electronic device or another associated device). Each of the representations may include a corresponding availability state for messaging.

An operation 304 obtains a message for the user of the target electronic device at the electronic device. The message may be obtained by the electronic device based on user input, selected from a plurality of preset messages using the electronic device, received from another computing device, and/or the like.

An operation 306 causes the message for the user of the target electronic device to be sent to a user device associated with the user. In some examples, the operation 306 sends the message for the user of the target electronic device from the electronic device to the target electronic device, with the message being relayed to the user device associated with the user via the target electronic device. The message may be received at the target electronic device using a first wireless connection and sent to the user device using a second wireless connection. The first wireless connection may use a communication protocol different from the second wireless connection. A notification from the target electronic device may be received at the electronic device in response to receipt of a request for message delivery from the electronic device, the message from the electronic device, and/or other communications. The notification may be a communication and/or include visual, audio, and/or tactile feedback and may be presented by the target electronic device, the electronic device, and/or other devices.

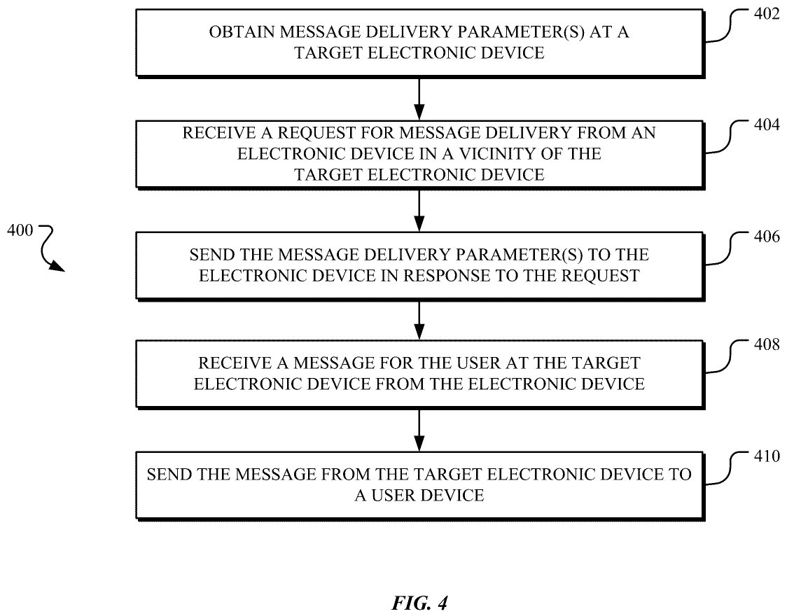

Turning to FIG. 4, example operations 400 for device messaging are illustrated. In some implementations, an operation 402 obtains one or more message delivery parameters at a target electronic device. The one or more message delivery parameters may be customized using user input from a user associated with the target electronic device. In some examples, the one or more message delivery parameters include one or more preset messages, with the message being selected from the one or more preset messages.

An operation 404 receives a request for message delivery from a electronic device in a vicinity of the target electronic device, and an operation 406 sends the one or more message delivery parameters to the electronic device in response to the request for message delivery. The one or more delivery parameters may be sent when the target electronic device is in a first state and the request for message delivery is denied when the target electronic device is in a second state. The first state may be an available state. For example, the first state may include the target electronic device being unattended by the user of the target electronic device (e.g., the target electronic device being locked).

An operation 408 receives a message for the user at the target electronic device from the electronic device. In some examples, the message is configured according to the one or more message delivery parameters. The message may be analyzed for compliance with the one or more message delivery parameters prior to sending the message to the user device. An operation 410 sends the message from the target electronic device to a user device associated with the user. The message may be sent from the target electronic device to the user device synchronously with receipt from the electronic device, analyzed for compliance with the message delivery parameter(s) prior to sending, and/or the like.

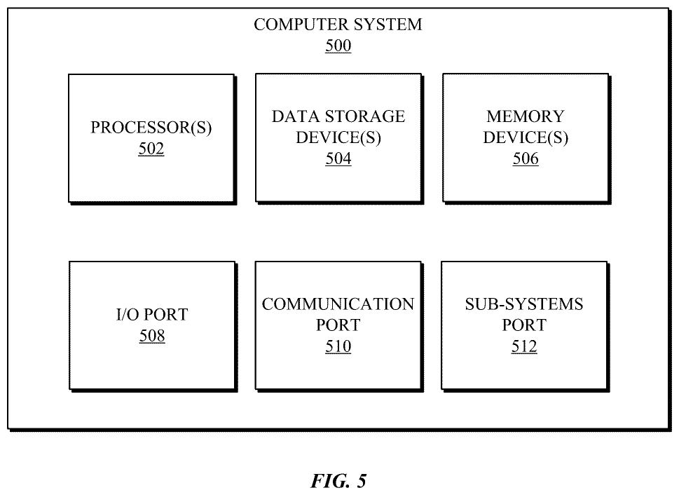

Referring to FIG. 5, a detailed description of an example computing device 500 having one or more computing units that may implement various systems and methods discussed herein is provided. Various components of the computing device 500 can be formed into a specific, non-conventional, and non-generic arrangement to achieve the various technological solutions discussed herein. As such, the computing device 500 and/or components of the computing device 500 may be applicable to the first electronic device 102, the second electronic device(s) 106, the target electronic device 108, the user device 110, various systems and subsystems of the electronic device 200, the various communication systems described herein, and other computing or network devices. In some examples, the target electronic device 108 and the first electronic device 102 are vehicles, but it will be appreciated that these devices may be various types of electronic devices, such as robots, user devices, computing systems, and so forth. It will be appreciated that specific implementations of these devices may be of differing possible specific computing architectures not all of which are specifically discussed herein but will be understood by those of ordinary skill in the art.

The computing device 500 may be a computing system capable of executing a computer program product to execute a computer process. Data and program files may be input to the computing device 500, which reads the files and executes the programs therein. Some of the elements of the computing device 500 are shown in FIG. 5, including one or more hardware processor(s) 502, one or more data storage device(s) 504, one or more memory device(s) 506, and/or one or more port(s) 508-512. Additionally, other elements that will be recognized by those skilled in the art may be included in the computing device 500 but are not explicitly depicted in FIG. 5 or discussed further herein. Various elements of the computing device 500 may communicate with one another by way of one or more communication buses, point-to-point communication paths, or other communication means not explicitly depicted in FIG. 5.

The processor 502 may include, for example, a central processing unit (CPU), a microprocessor, a microcontroller, a digital signal processor (DSP), and/or one or more internal levels of cache. There may be one or more processors 502, such that the processor 502 comprises a single central-processing unit, or a plurality of processing units capable of executing instructions and performing operations in parallel with each other, commonly referred to as a parallel processing environment.

The computing device 500 may be a conventional computer, a distributed computer, or any other type of computer, such as one or more external computers made available via a cloud computing architecture. The presently described technology is optionally implemented in software stored on the data stored device(s) 504, stored on the memory device(s) 506, and/or communicated via one or more of the ports 508-512, thereby transforming the computing device 500 in FIG. 5 to a special purpose machine for implementing the operations described herein. Examples of the computing device 500 include personal computers, servers, purpose-built autonomy processors, terminals, workstations, mobile phones, tablets, laptops, so forth.

The one or more data storage devices 504 may include any non-volatile data storage device capable of storing data generated or employed within the computing device 500, such as computer executable instructions for performing a computer process, which may include instructions of both application programs and an operating system (OS) that manages the various components of the computing device 500. The data storage devices 504 may include, without limitation, magnetic disk drives, optical disk drives, solid state drives (SSDs), flash drives, so forth. The data storage devices 504 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and so forth. Examples of non-removable data storage media include internal magnetic hard disks, SSDs, and so forth. The one or more memory devices 506 may include volatile memory (e.g., dynamic random-access memory (DRAM), static random-access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 504 and/or the memory devices 506, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computing device 500 includes one or more port(s), such as an input/output (I/O) port(s) 508, communication port(s) 510, and sub-systems port(s) 512, for communicating with other computing, network, or electronic devices. It will be appreciated that the ports 508-512 may be combined or separate and that more or fewer ports may be included in the computing device 500.

The I/O port 508 may be connected to an I/O device, or other device, by which information is input to or output from the computing device 500. Such I/O devices may include, without limitation, one or more input devices, output devices, and/or environment transducer devices.

In one implementation, the input devices convert a human-generated signal, such as, human voice, physical movement, physical touch or pressure, so forth, into electrical signals as input data into the computing device 500 via the I/O port 508. Similarly, the output devices may convert electrical signals received from computing device 500 via the I/O port 508 into signals that may be sensed as output by a human, such as sound, light, and/or touch. The input device may be an alphanumeric input device, including alphanumeric and other keys for communicating information and/or command selections to the processor 502 via the I/O port 508. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, so forth. In some implementations, the input device and the output device may be the same device, for example, in the case of a touchscreen.

The environment transducer devices convert one form of energy or signal into another for input into or output from the computing device 500 via the I/O port 508. For example, an electrical signal generated within the computing device 500 may be converted to another type of signal, and/or vice-versa. In one implementation, the environment transducer devices sense characteristics or aspects of an environment local to or remote from the computing device 500. Further, the environment transducer devices may generate signals to impose some effect on the environment either local to or remote from the example computing device 500.

In one implementation, a communication port 510 is connected to a network by way of which the computing device 500 may receive network data useful in executing the methods and systems set out herein as well as transmitting information and network configuration changes determined thereby. Stated differently, the communication port 510 connects the computing device 500 to one or more communication interface devices configured to transmit and/or receive information between the computing device 500 and other devices by way of one or more wired or wireless communication networks or connections. Examples of such networks or connections include, without limitation, Universal Serial Bus (USB), Ethernet, Wi-Fi, Bluetooth, Near Field Communication (NFC), cellular, and so on. One or more such communication interface devices may be utilized via the communication port 510 to communicate one or more other machines, either directly over a point-to-point communication path, over a wide area network (WAN) (e.g., the Internet), over a local area network (LAN), over a cellular (e.g., third generation (3G), fourth generation (4G) network, or fifth generation (5G)), network, or over another communication means. Further, the communication port 510 may communicate with an antenna for electromagnetic signal transmission and/or reception. In some examples, an antenna may be employed to receive Global Positioning System (GPS) data to facilitate determination of a location of a device.

The electronic devices discussed herein may include a mobile device. The computing device 500 may include a sub-systems port 512 for communicating with one or more systems to control an operation of the mobile device and/or exchange information between the computing device 500 and one or more sub-systems of the mobile device. Examples of such sub-systems, include, without limitation, imaging systems, radar, LIDAR, motor controllers and systems, battery control, fuel cell or other energy storage systems or controls, hybrid or electric motor systems, processors and controllers, steering systems, brake systems, light systems, navigation systems, environment controls, entertainment systems, and so forth.

The present disclosure recognizes that participation in messaging may be used to the benefit of users. Entities implementing the present technologies should comply with established privacy policies and/or practices that meet or exceed industry or governmental requirements for maintaining the privacy and security of data being communicated. The present disclosure contemplates that devices participating in the messaging, such as the first electronic device 102, the target electronic device 108, and the user device 110, would provide input interfaces for specifying when, where, and what types of communications are to occur, thereby permitting users to customize their intended functionality. Moreover, users should be allowed to opt-in or opt-out of allowing a device to participate in such services. In addition, particular information that is being communicated, such as messages and recipients, can be encrypted, structured, and/or coded to further maintain privacy and security. Third parties can evaluate these implementers to certify their adherence to established privacy policies and practices.

The system set forth in FIG. 5 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order and are not necessarily meant to be limited to the specific order or hierarchy presented. The described disclosure may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer).

While the present disclosure has been described with reference to various implementations, it will be understood that these implementations are illustrative and that the scope of the present disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method for message delivery, the method comprising:
identifying a target electronic device in a vicinity of an electronic device, wherein the target electronic device is in an available state for messaging;
obtaining a message for a user of the target electronic device at the electronic device;
sending the message for the user of the target electronic device from the electronic device to the target electronic device, the message being relayed to a user device associated with the user via the target electronic device.

2. The method of claim 1, where identifying the target electronic device in the vicinity of the electronic device comprises:
detecting one or more electronic devices in the vicinity of the electronic device; and
obtaining a selection of the target electronic device, the target electronic device selected from the one or more electronic devices.

3. The method of claim 2, further comprising:
scanning the vicinity using a camera of the electronic device, the one or more electronic devices detected in the vicinity using the camera.

4. The method of claim 2, further comprising:
transmitting wireless communication signals using a communication system of the electronic device, the one or more electronic devices detected in the vicinity using one or more communications responding to the wireless communication signals.

5. The method of claim 2, further comprising:
detecting one or more discoverable devices on a wireless network using a communication system of the electronic device, the one or more electronic devices detected from the one or more discoverable devices.

6. The method of claim 2, wherein the communication system includes at least one antenna of the electronic device, the at least one antenna including a UWB antenna and transmitting the wireless communication signals comprises transmitting ultra-wideband (UWB) positioning signals using the UWB antenna.

7. The method of claim 2, wherein the selection of the target electronic device is obtained based on detection of a device messaging condition corresponding to the target electronic device.

8. The method of claim 2, wherein a representation of each of the one or more electronic devices is presented using a display, the representation of each of the one or more electronic devices including a corresponding availability state for messaging.

9. The method of claim 1, further comprising:
receiving a notification from the target electronic device in response to at least one of receipt of a request for message delivery from the electronic device or receipt of the message from the electronic device.

10. The method of claim 1, wherein the target electronic device is unknown to the electronic device.

11. The method of claim 1, wherein the available state includes the target electronic device being unattended by the user of the target electronic device.

12. One or more tangible non-transitory computer-readable storage media storing computer-executable instructions for performing a computer process on a computing system, the computer process comprising:
identifying a target electronic device in a vicinity of an electronic device, wherein the target electronic device is in an available state for messaging;
obtaining a message for the user of the target electronic device at the electronic device; and
causing the message for the user of the target electronic device to be sent to a user device associated with the user.

13. The one or more tangible non-transitory computer-readable storage media of claim 12, wherein the message for the user of the target electronic device is sent from the electronic device to the user device associated with the user via the target electronic device.

14. The one or more tangible non-transitory computer-readable storage media of claim 12, wherein the available state includes the target electronic device being unattended by the user of the target electronic device.

15. The one or more tangible non-transitory computer-readable storage media of claim 12, wherein the user device is a smartphone or a wearable.

16. The one or more tangible non-transitory computer-readable storage media of claim 12, wherein the target electronic device is identified based on discoverability on a network.

17. The one or more tangible non-transitory computer-readable storage media of claim 12, wherein the target electronic device is unknown to the electronic device.

18. A system for message delivery, the system comprising:
at least one processor configured to identify a target electronic device in a vicinity of an electronic device;
an input system configured to capture a message for the user of the target electronic device; and
a communication system configured to send the message to the target electronic device, the message being sent to the target electronic device causing the message for the user of the target electronic device to be sent to a user device associated with the user.

19. The system of claim 18, wherein the message is received at the target electronic device using a first wireless connection and sent to the user device using a second wireless connection.

20. The system of claim 18, wherein the target electronic device is unknown to the electronic device.
